(19) United States
(12) Patent Application Publication
(10) Pub. No.: US 2009/0254243 A1
(43) Pub. Date: Oct. 8, 2009

(54) ON-BOARD MACHINE, FREQUENCY COLLECTING DEVICE, AND FREQUENCY COLLECTING METHOD

(75) Inventors: Koji Uchihashi, Kobe-shi (JP); Takehito Iwanaga, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, Kobe-shi (JP)

(21) Appl. No.: 12/440,636

(22) PCT Filed: Sep. 27, 2007
(86) PCT No.: PCT/JP2007/068884

§ 371 Date: Mar. 10, 2009

(30) Foreign Application Priority Data
Sep. 28, 2006 (JP) 2006-264872

(51) Int. Cl. G01M 17/007

(52) U.S. Cl. 701/33

(57) ABSTRACT

Provided is an on-board machine capable of readily examining whether a self-diagnosing mechanism operates in a normal manner while satisfying statutory requirements. The on-board machine includes an EEPROM for storing a failure diagnosis executing frequency calculated on the basis of a failure diagnosis executed by an electronic control device under a predetermined travel condition set in advance, and a control portion for transmitting the failure diagnosis executing frequency stored in the EEPROM in response to a transmission demand for the executing frequency of the failure diagnosis from an external frequency collecting device 3 when the failure diagnosis executing frequency is within a predetermined frequency range.

This application is the U.S. national phase of international application PCT/JP2007/068884, filed on Sep. 27, 2007, which designated the U.S. and claims priority to JP Application No. 2006-264872, filed on Sep. 28, 2006. The entire contents of these applications are incorporated herein by reference.

### TECHNICAL FIELD

The present invention relates to an on-board machine for controlling an executing frequency (hereinafter also referred to as “monitoring frequency” in this specification) of a failure diagnosis under a predetermined travel condition, a frequency collecting device for concentrating a monitoring frequency from outside a vehicle, and a frequency collecting method.

### BACKGROUND ART

In recent years, in order to prevent serious accidents and environmental destruction, control devices in vehicles are equipped with various self-diagnosing mechanisms. In order to make these self-diagnosing mechanisms effective, they are subject to legal control in some cases.

For example, as described in patent document 1, OBD2 regulations by the CARB (California Air Resources Board) require all vehicles marketed in the United States to be equipped with electronic control devices (the electronic control devices being hereinafter also referred to as “ECUs (Electronic Control Units)”) provided with a monitoring function to see whether systems associated with discharge gas generation from engines operate normally, in order to prevent harmful discharge gas from being emitted due to abnormalities within the engines.

A function that detects information about failure of an engine and the like with an ECU and stores a result of the detection in a nonvolatile memory such as an EEPROM is referred to as an OBD (On Board Diagnosis).

For example, the Rate Based Monitoring Act of OBD2 requires, in relation to IPT (In-use Performance Tracking) of service $09, that a monitoring frequency represented as follows be continually stored in a nonvolatile memory.

Monitoring frequency=Number of times of monitoring/Number of times of travel

That is, the monitoring frequency is defined by a ratio between a counted value indicating the number of times of travel counted when a predetermined travel condition is satisfied and a counted value indicating the number of times of monitoring counted when a judgment as to normality or abnormality is made by a failure diagnosis carried out during the travel. The monitoring frequency is controlled for a plurality of failure diagnosis target items such as a catalytic converter, a fuel evaporation system, and an oxygen sensor.

The number of times of travel refers to data with an increment that is made every time when a predetermined, statutory travel condition is satisfied in an item, and the number of times of monitoring refers to data with an increment that is made upon completion of a judgment as to normality or abnormality when a failure diagnosis execution condition specified by an automobile manufacturer is satisfied in an item.

The failure diagnosis target items specified by the Rate Based Monitoring Act of OBD2 of the CARB are configured, for example, such that when a failure diagnosis execution condition, that is, a travel condition associated with a failure diagnosis target item is fulfilled, then an engine ECU executes failure diagnosis processing with respect to the item in order to carry out a judgment as to normality or abnormality, and counts up data stored in storage areas delimited in a nonvolatile memory for the number of times of monitoring and the number of times of travel in each of the failure diagnosis target items, thus carrying out continual preservations and updates. When, as a result of the failure diagnosis, the judgment cannot be made for normality or abnormality, the number of times of monitoring is not counted up so that the previous value is maintained.

During check work and the like of a vehicle at a repair shop, the monitoring frequency stored in the nonvolatile memory is configured to be collected into an external diagnosis device such as a handy terminal connected to a diagnostic connector that a maintenance engineer provides in the vehicle.

For the purpose of eliminating inappropriate, unnecessary processing between a vehicle and a base station that receives failure diagnosis information during a check, a repair, and a maintenance that accord with the failure diagnosis information of the vehicle, patent document 2 proposes a vehicle diagnosis system such that when a self diagnosis executed by an ECU results in a judgment for abnormality, corresponding failure diagnosis information is transmitted from the vehicle to the base station side in a wireless manner, while when thereafter an abnormality of the vehicle corresponding to the failure diagnosis information is eliminated, abnormality elimination information is transmitted similarly from the vehicle to the base station side in a wireless manner.

[Patent Document 1] Japanese Unexamined Patent Publication No. 2004-152387

[Patent Document 2] Japanese Unexamined Patent Publication No. 11-223578

### DISCLOSURE OF THE INVENTION

### Problems that the Invention is to Solve

According to the conventional technique recited in patent document 1, however, an examination as to whether the above-described self-diagnosing mechanism operates in a normal manner while satisfying statutory requirements necessitates laborious work including bringing the vehicle to a repair shop and the like and collecting the monitoring frequency by connecting the external diagnosis device to the diagnostic connector, thus posing the problem of practical difficulty in collecting such information from many vehicles.

The vehicle diagnosis system recited in patent document 2 merely transmits failure diagnosis information from the vehicle to the base station in a wireless manner when the self-diagnosing mechanism detects an abnormality; no failure diagnosis information is transmitted to the base station in a wireless manner when the self-diagnosing mechanism makes a judgment for normality, and thus the monitoring frequency cannot be collected. Thus, such a configuration that vehicles transmit respective monitoring frequencies to the base station every time self-diagnosing mechanisms provided in the vehicles update and store the monitoring frequencies makes the communication traffic enormous and thus is not practical.

In view of the foregoing conventional problems, it is an object of the present invention to provide an on-board machine, a frequency collecting device, and a frequency collecting method that are capable of readily examining whether a self-diagnosing mechanism operates in a normal manner while satisfying statutory requirements.

### Means of Solving the Problems

In order to accomplish the above object, a feature configuration of an on-board machine according to the present invention is as follows. A failure-diagnosing on-board machine provided in a vehicle includes: a storing portion for storing information related to a failure diagnosis; and a control portion for, upon receiving a transmission demand from an external frequency collecting device, transmitting an executing frequency of the failure diagnosis on the basis of the information related to the failure diagnosis stored in the storing portion, the failure diagnosis being executed when a predetermined travel condition is satisfied.

With the above configuration, failure diagnosis executing frequencies are transmitted from vehicles only when a demand is made from a frequency collecting device, and thus the failure diagnosis executing frequencies of the vehicles are controlled while being collected to the frequency collecting device without causing an excessive increase in communication traffic.

A feature configuration of a frequency collecting device according to the present invention is as follows. A frequency collecting device includes: a vehicle database for storing vehicle information including a failure diagnosis executing frequency calculated from a failure diagnosis of a vehicle; a target vehicle extracting portion for extracting a concentration target vehicle from the vehicle database; and a frequency concentrating portion for concentrating through a communication line the failure diagnosis executing frequency from the concentration target vehicle extracted by the target vehicle extracting portion and for registering the failure diagnosis executing frequency to the vehicle database. The target vehicle extracting portion extracts the concentration target vehicle on the basis of production control information including at least a type and a production time of the vehicle.

With the above configuration, when the frequency collecting device collects failure diagnosis executing frequencies of vehicles, the target vehicle extracting portion focuses on a concentration target vehicle on the basis of production control information including at least a type and a production time of the vehicle, and the frequency concentrating portion collects the failure diagnosis executing frequency of the focused vehicle, thus making it possible to effectively concentrating the failure diagnosis executing frequency of the desired vehicle without congestion of the communication traffic.

### EFFECTS OF THE INVENTION

According to the present invention, it has been made possible to provide an on-board machine, a frequency collecting device, and a frequency collecting method that are capable of readily examining whether a self-diagnosing mechanism operates in a normal manner while satisfying statutory requirements.

### BRIEF DESCRIPTION OF THE DRAWINGS

FIG. 1 is a diagram illustrating a monitoring frequency control system.

FIG. 2 is a functional block configuration diagram of an on-board machine and a monitoring frequency collecting device.

FIG. 3 is a diagram illustrating a vehicle database.

FIG. 4 is a diagram illustrating information transmission-reception between the monitoring frequency collecting device, a retailer, a developer-manufacturer, and a vehicle.

FIG. 5 is a flowchart describing a vehicle diagnosis operation carried out by the on-board machine and the monitoring frequency collecting device.

### DESCRIPTION OF REFERENCE NUMERAL

1 Monitoring frequency control system
3 Monitoring frequency collecting device
4 ECU
5 CAN bus
6 Retailer
7 Developer-manufacturer
21 Self-diagnosing portion
22 On-board machine
31 Vehicle database
32 Target vehicle extracting portion
33 Monitoring frequency concentrating device
34 Monitoring frequency evaluating device
35 Maintenance notifying portion
36 Repair confirming portion
41 Engine ECU
42 AT control-dedicated ECU
43 Brake control-dedicated ECU
221 EEPROM

### BEST MODE FOR CARRYING OUT THE INVENTION

An on-board machine, a frequency collecting device that collects a monitoring frequency from outside a vehicle, and a frequency collecting method according to the present invention will be described below.

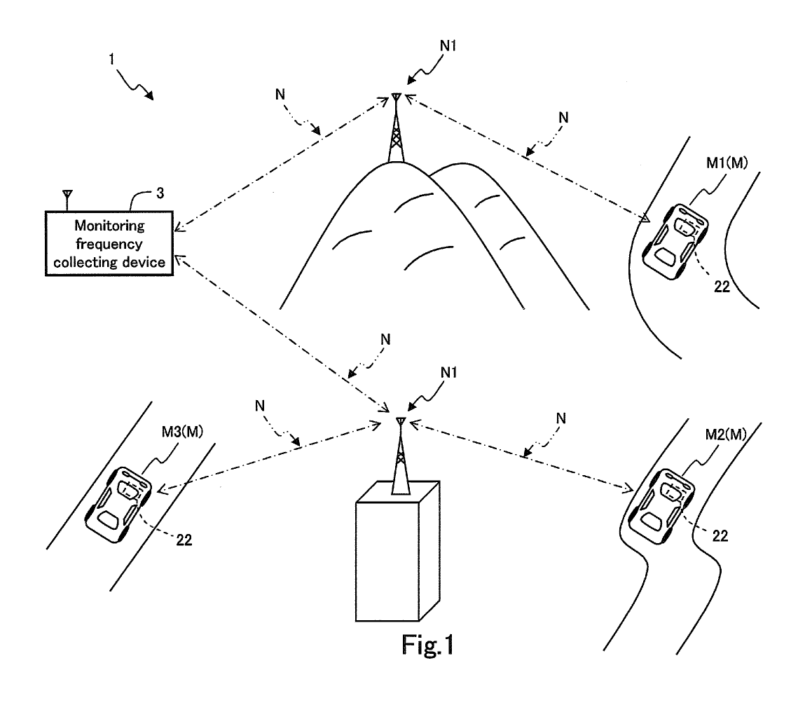

Referring to FIG. 1, a monitoring frequency control system 1 that controls an executing frequency of a failure diagnosis is configured to include a plurality of vehicles M (three vehicles, M1 to M3, in FIG. 1) each including an on-board machine 22 for carrying out a failure diagnosis of a corresponding vehicle, a frequency collecting device 3 (hereinafter referred to as “monitoring frequency collecting device 3”) serving as an information control center that collects failure diagnosis executing frequency information (hereinafter referred to as “monitoring frequency information”) from each of the vehicles M, and mobile communication networks N for connecting the vehicles M and the monitoring frequency collecting device 3 with each other in a wirelessly communicable manner.

As the mobile communication networks N, mobile phone lines are used for data communication between, through relay stations N1, the vehicles M and the monitoring frequency collecting device 3, which is located at an area apart from the vehicles M. It should be noted that the mobile communication networks are not limited to mobile phone lines; other forms of communication infrastructure may be used such as wireless LANs and satellite communication lines.

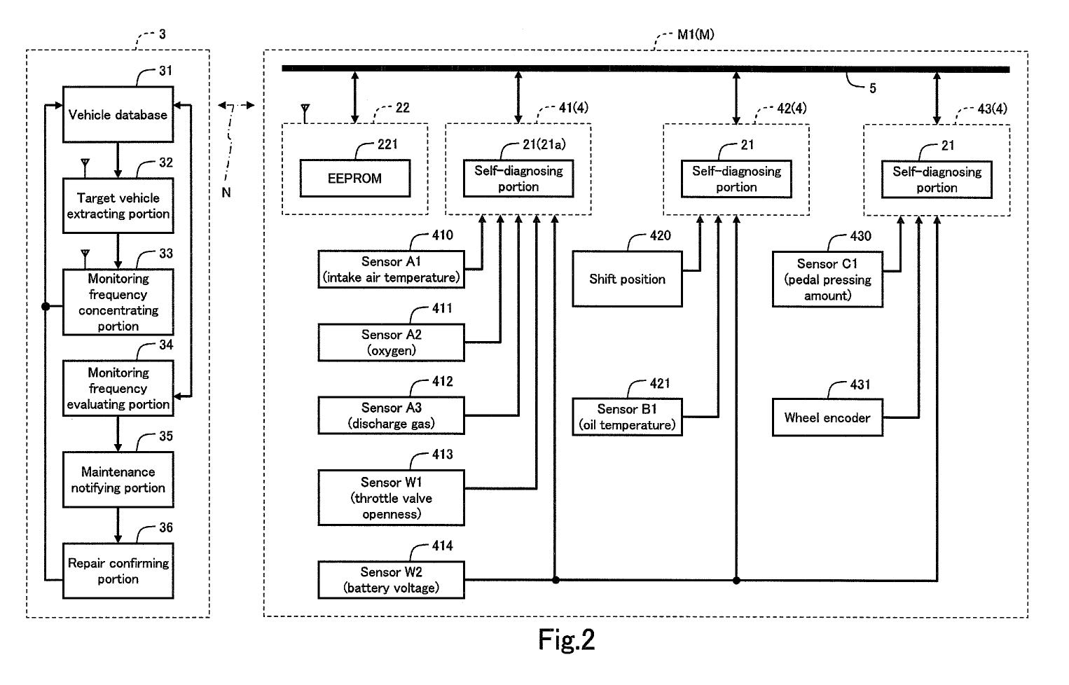

Referring to FIG. 2, each of the vehicles M is equipped with a plurality of ECUs 4 for electronically controlling a plurality of functional blocks including an engine, a transmission, and a brake, and the ECUs 4 are network-connected with each other through a CAN (Controller Area Network) bus 5 so that they are travel-controlled together as a whole. While FIG. 2 shows a detailed configuration of a vehicle M1 alone, other vehicles M2 and M3 have the same configurations.

Specifically, each of the vehicles M is equipped with a plurality of ECUs 4 including an engine ECU 41 for driving and controlling an engine, an automatic transmission (AT) control-dedicated ECU 42, a brake control-dedicated ECU 43, and an on-board machine 22 serving as a communication ECU that transmits failure diagnosis information to the monitoring frequency collecting device 3.

Each of the ECUs 4 is configured to include a CPU, a ROM, an EEPROM, a RAM, and the like. The CPU repeatedly executes a built-in program stored in the ROM, EEPROM, or the like at predetermined intervals to process the values of sensors provided in the functional blocks and built-in data stored in the EEPROM, RAM, or the like and to control the functional blocks on the basis of the processing, thereby causing the functional blocks to exhibit respective, predetermined functions.

For example, the engine control-dedicated ECU 41 carries out driving and control to keep the engine at an appropriate rotational number by controlling the amount of fuel supply to the engine at a predetermined amount of supply on the basis of output signals of sensors such as an intake air temperature sensor 410, an oxygen sensor 411, a discharge gas (air-fuel ratio) sensor 412, a throttle valve openness sensor 413, and a battery voltage sensor 414, and on the basis of communication data from other associated ECUs such as the automatic transmission control-dedicated ECU 42.

The automatic transmission control-dedicated ECU 42 executes switching of a speed range by an input from a shift position 420 and switching of oil pressure by an oil pressure sensor, and the brake control-dedicated ECU 43 executes oil pressure control of a brake system and the like on the basis of output signals of a pedal pressing amount sensor 430 and a wheel encoder 431.

The ECUs 41, 42, and 43 are each provided with a self-diagnosing portion 21 for diagnosing whether the control target blocks operate normally. The self-diagnosing portion 21 is realized by the CPU, the ROM, the EEPROM, the RAM, and the like provided in each ECU 4.

That is, the CPU is configured to repeatedly execute a self-diagnosis at predetermined intervals on the basis of a self-diagnosis program stored in the ROM, the EEPROM, or the like and on the basis of parameters and variables (such as the number of times of monitoring and the number of times of travel, described later) used in this program and stored in the EEPROM, the RAM, or the like.

Then, diagnosis information including a monitoring frequency generated by each self-diagnosing portion 21 is transmitted to the on-board machine 22 through the CAN bus 5 and stored in an EEPROM 221, which is a nonvolatile memory provided in the on-board machine 22.

The self-diagnosing portion 21 carries out a failure diagnosis when a predetermined travel condition set in advance on a failure diagnosis target item basis is satisfied, and cumulatively records a predetermined monitoring frequency in the EEPROM or the RAM. It should be noted that the RAM is configured to be fed power from a battery even in the state where an ignition switch is off, so that stored data is not lost.

The term “monitoring frequency” refers to an executing rate of the failure diagnosis by the self-diagnosing portion 21 with respect to sensors provided in the vehicle, and the Rate Based Monitoring Act specifies such an obligation that the monitoring frequency must be equal to or more than a predetermined specified value.

When the executing rate of the failure diagnosis is low in the case of failure in the sensors provided in the vehicle, notification to the driver is delayed and a repair is also delayed. If the vehicle travels while the sensors are in failed states, an inhibiting function against harmful discharge gas might not work, resulting in more serious pollution.

As an example of the function to inhibit discharge of harmful gas, the engine control-dedicated ECU 41 realizes a function that detects gas resulting from combustion in an engine cylinder with an A/F (air-fuel ratio) sensor and carries out, on the basis of the concentration of oxygen contained in the discharge gas, feedback control (stoichiometric control) of an injector so that the ratio between fuel and air becomes a theoretical air-fuel ratio, thereby detoxifying harmful discharge gas as much as possible through a three-way catalyst device.

However, if the vehicle travels while the A/F sensor is in a failed state, this function might not work appropriately, causing emission of harmful discharge gas and resulting in occurrence of pollution.

In case of such a situation, the Rate Based Monitoring Act is established for purposes including preserving the environment, prompting a repair by notifying early the user about a case of failure in the vehicle and the like, and preventing occurrence of pollution and the like resulting from failure.

Satisfying the above predetermined travel conditions refers to fulfilling the following conditions (1), (2), and (3), for example.

(1) Premises

i) The engine rotational number after activation of the engine is equal to or more than 600 (rpm).

ii) Outside temperature≧−6.7 (° C.).

iii) An altitude of less than 8000 (feet).

(2) The following condition lasts for a predetermined period of time or longer.

i) Vehicle speed≧41 (km/h).

(3) The following conditions last for a predetermined period of time or longer.

i) Idling ON

ii) Vehicle speed≦1 (km/h).

For example, a travel condition is set on the basis of assumptions including such an assumption that an appropriate failure diagnosis is executable when the vehicle has a predetermined condition such as traveling at a vehicle speed of equal to or higher than 41 km. When the vehicle has the set travel condition, a failure diagnosis is carried out without exception, and when there is a failure, the user is notified to prompt a repair, thereby attempting to prevent occurrence of pollution caused by failure. It should be noted that the travel conditions are subject to change appropriately in accordance with amendment of associated laws.

The monitoring frequency is defined by a ratio between a counted value indicating the number of times of travel counted when the above predetermined travel condition is satisfied and a counted value indicating the number of times of monitoring counted when a judgment as to normality or abnormality is made by a failure diagnosis carried out during the travel.

Monitoring frequency=Number of times of monitoring/Number of times of travel

For example, when the above travel condition is satisfied, a self-diagnosing portion 21a configured in the engine ECU 41 carries out a diagnosis as to normality or abnormality by detecting a value of a sensor associated with a diagnosis target item input at a predetermined timing and an operation result of a driven actuator, and, for every diagnosis, makes an increment to the counted value of the number of times of travel while at the same time making an increment to the counted value of the number of times of monitoring. When, as a result of the diagnosis, the judgment cannot be made for normality or abnormality, the counted number of times of travel is incremented, while the counted number of times of monitoring is not counted up so that the previous value is maintained.

Thus, the monitoring frequency is not updated when a predetermined travel condition set on a failure diagnosis target item basis is not satisfied, while when no judgment is made for normality or abnormality even though the predetermined travel condition is satisfied, the counted number of times of monitoring is not updated so that the previous value is maintained. The self-diagnosing portion 21 is also configured to control, as a failure diagnosis history, the occurrence date and the repair date of a detected failure.

The on-board machine 22 is configured to include a communication portion, a CPU, a ROM that stores a control program, an EEPROM 221 that stores diagnosis information such as a monitoring frequency, area-of-sale information and travel distance information of the corresponding vehicle, and a RAM that is regularly fed power from a battery regardless of the state of an ignition switch.

When the communication portion receives a transmission demand for information of the monitoring frequency and the like from the external monitoring frequency collecting device 3 through the above mobile phone line, which is the mobile communication network N, then the CPU transmits, in response to the transmission demand, the information such as the monitoring frequency and the like stored in the EEPROM 221 to the external monitoring frequency collecting device 3 through the communication portion.

The CPU temporarily buffers in the RAM diagnosis information and the like input from the ECUs 41, 42, and 43 through the CAN bus 5, and updates and stores the diagnosis information and the like in the EEPROM 221 at a timing of turning off the ignition switch. That is, the diagnosis information and the like input through the CAN bus 5 within the period of time between ON and OFF of the ignition switch is configured to be transmitted after the ignition switch is next turned on in response to the transmission demand from the monitoring frequency collecting device 3.

Various diagnosis information and the like input through the CAN bus 5 after the ignition switch is turned on and before the ignition switch is turned off may vary due to travel and the like that follow and thus are updated collectively when the ignition switch is turned off.

That is, a block of the on-board machine 22 executing the above transmitting and receiving processing serves as a control portion for transmitting, in response to the transmission demand from the external monitoring frequency collecting device 3, predetermined monitoring frequencies calculated from failure diagnoses carried out by the ECUs 41, 42, and 43.

It should be noted that the communication portion is composed of hardware such as an interface board for controlling communication between the on-board machine 22 and an external appliance, and may be provided inside or outside the on-board machine 22.

The control portion carries out control to transmit the monitoring frequency in response to the transmission demand from the monitoring frequency collecting device 3 when the counted value of the number of times of travel is equal to or more than a predetermined counted value or when the monitoring frequency is within a predetermined frequency range, thereby avoiding increased communication traffic caused by transmission of unnecessary data not worthy of evaluation.

For example, in response to the transmission demand from the monitoring frequency collecting device 3, the control portion sets in advance a threshold value for the number of times of travel by which to judge whether to transmit the monitoring frequency in return. When the counted value of the number of times of travel is smaller than the threshold value at the time of the transmission demand, the control portion judges that a problem exists in the credibility of data because the number of sample data is small, thus avoiding transmission of the monitoring frequency.

When transmitting the monitoring frequency to the monitoring frequency collecting device 3, the control portion notifies the driver by carrying out control to display, on a display lamp or a liquid crystal display portion provided on an instrumental panel, a lamp or a message while the monitoring frequency and the like is being transmitted.

Here the control portion may also carry out control to display, on the liquid crystal display portion, information that is being transmitted to the monitoring frequency collecting device 3 such as the monitoring frequency. In this case, the driver can be notified what kind of information is being transmitted.

Such a notifying function can be realized by such a configuration that the control portion directly carries out display control of the display lamp or the liquid crystal display portion. The notifying function can also be realized by such a configuration that the control portion carries out display control through an ECU dedicated to instrument panel control and connected to the CAN bus 5.

The control portion is configured such that when a signal is input to the control portion from a transmission control switch provided in the vicinity of the door beside the driver's seat while there is a transmission demand for a monitoring frequency from the monitoring frequency collecting device 3, then the control portion permits transmission of the monitoring frequency when the driver carries out an ON operation of a transmission control switch, while prohibiting transmission of the monitoring frequency when the driver carries out an OFF operation of the transmission control switch. By the driver's ON or OFF operation of the transmission control switch, whether to provide vehicle information such as the monitoring frequency and the like to a third party is changed, thus taking into consideration the driver's will as to whether to externally transmit information about the driver's vehicle.

Referring to FIG. 2, the monitoring frequency collecting device 3 is configured to include a vehicle database 31 for storing vehicle information including a monitoring frequency, a target vehicle extracting portion 32 for extracting a concentration target vehicle from the vehicle database 31, a monitoring frequency concentrating portion 33 for concentrating the monitoring frequency from a concentration target vehicle extracted by the target vehicle extracting portion 32 through the communication line, that is, the mobile phone line, which is the mobile communication network N, and for registering the monitoring frequency to the vehicle database 31, and a monitoring frequency evaluating portion 34 for evaluating, based on the concentrated monitoring frequency, whether the self-diagnosing portion 21 provided in the vehicle operates normally.

With the above configuration, on the basis of production control information including a type and a production time of the vehicle registered in the vehicle database 31, the target vehicle extracting portion 32 focuses on a concentration target vehicle, and the monitoring frequency concentrating portion 33 concentrates a monitoring frequency from each vehicle M for the focused concentration target vehicle, thereby making it possible to appropriately and efficiently collect the monitoring frequency without increasing the communication traffic.

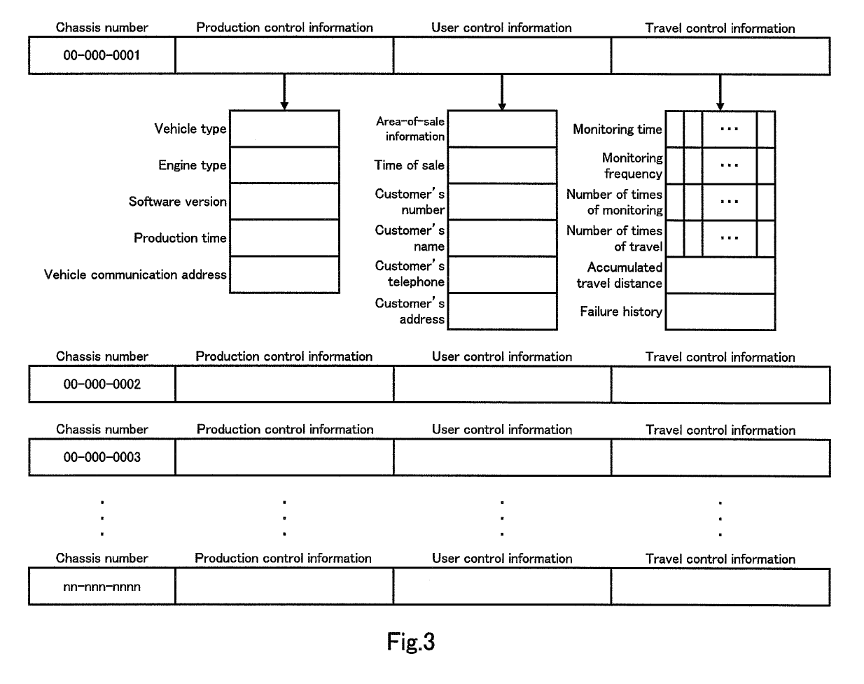

Detailed description will be made below. Referring to FIG. 3, the vehicle database 31 includes a plurality of records classified on a control target vehicle basis, and each record includes field data including a chassis number field for uniquely identifying a vehicle, a production control information field for recording production control information of the vehicle, user control information field for recording owner information of the vehicle, and a travel control information field for recording travel control information such as the monitoring frequency of the vehicle.

The production control information field includes field data including a type of the vehicle, an engine type, a version of software provided in the engine and the like, a production time (L/O), and a vehicle communication address.

The vehicle communication address serves as address information for communication with the vehicle such as an IP address allotted to the vehicle when, for example, an Internet connection is made through the communication portion.

It should be noted that the vehicle communication address is not limited to the IP address allotted to the vehicle; when a communication is made through a mobile phone of the owner, address information of the mobile phone is stored. In this case, the vehicle communication address may be stored in the user control information field.

The user control information field includes field data including retailer information indicating an area of sale, time of sale, a customer ID number, a customer name, a customer telephone number, and a customer address.

The travel control information field includes field data including a monitoring time indicating the time and date of a concentration from the vehicle by the monitoring frequency concentrating portion 33, a monitoring frequency concentrated on a failure diagnosis target basis on this occasion, the number of times of monitoring, the number of times of travel, and further, an accumulated travel distance and failure diagnosis history of the vehicle.

The target vehicle extracting portion 32 is configured to function as a scheduler that extracts concentration target vehicles from control target vehicles registered in the vehicle database 31 on the basis of the production control information including the type and the production time of the vehicles and that determines a concentration time so that the monitoring frequency concentrating portion 33 concentrates monitoring frequencies through sequential access to the concentration target vehicles at the determined time.

The monitoring frequency concentrating portion 33 repeatedly transmits a monitoring frequency transmission demand predetermined times at predetermined intervals until monitoring frequencies and the like are transmitted in return from the concentration target vehicles. Each of the predetermined intervals is set to become gradually longer. When the ignition switch of a concentration target vehicle is not turned on at the time when the monitoring frequency concentrating portion 33 transmits the transmission demand, the on-board machine 22 is not activated and therefore the monitoring frequency cannot be transmitted in return. The transmission demand cannot be received during travel through mountainous areas and the like where radio wave communication is not available. In view of this, the transmission demand is repeatedly transmitted in order to activate the on-board machine 22 of the concentration target vehicle or in order to secure increased opportunities for reception of the transmission demand.

Specifically, the target vehicle extracting portion 32 extracts target vehicles such that monitoring frequencies are concentrated upon elapse of every predetermined concentration period, e.g., six months, until elapse of a predetermined period of time, e.g., three years, counted from the production times (L/O) of the vehicles. Here priority for extraction is given to such vehicles that the monitoring frequency evaluating portion 34 evaluates that the self-diagnosing portion 21 does not operate normally on the basis of the monitoring frequencies and the like concentrated from the control target vehicles, or such vehicles that monitoring frequencies are yet to be concentrated from.

Specifically, in order to efficiently collect necessary evaluation data, the target vehicle extracting portion 32 extracts, as concentration target vehicles and on a particular type vehicle basis, vehicles in which the concentration time has passed on the basis of the production times of the vehicles, and prepares a concentration schedule. In addition, in the cases where the self-diagnosing portions are somewhat improved depending on the production times of the vehicles even though the types thereof are the same, the concentration target vehicles may be extracted on the basis of production control information including versions of software indicating the difference caused by the improvement.

Upon receiving access from the monitoring frequency concentrating portion 33 and a monitoring frequency transmission demand, the on-board machine 22 provided in each of the vehicles transmits the monitoring frequency and necessary information stored in the EEPROM 21, as described above. Specifically, the on-board machine 22 transmits vehicle side control information including the monitoring frequency, the number of times of monitoring, the number of times of travel, and further an accumulated travel distance and failure history of the vehicle, and area-of-sale information of the vehicle.

On the basis of concentrated data from a plurality of vehicles, the monitoring frequency evaluating portion 34 evaluates whether the monitoring frequency indicates a suitable value on the basis of the concentrated vehicle side control information, the evaluation being on a vehicle group basis specified by, for example, the vehicle type, engine type, the version of software provided in the engine, the production time (L/O), and the concentration time.

For example, with respect to a group of vehicles that have a common vehicle type, engine type, and version of software provided in the engine, and have a common production time (L/O) or the production time (L/O) is within a predetermined period of time, the monitoring frequency evaluating portion 34 judges whether the monitoring frequencies are secured within a predetermined variation range around an assumed design value on the basis of the accumulated travel distance. In the case of a large deviation, the monitoring frequency evaluating portion 34 judges that the self-diagnosing portion 21 does not operate normally.

As an evaluation condition, the evaluation may be carried out on the basis of, other than the accumulated travel distance, the concentration time or the area-of-sale information. When a basis is placed on the concentration time, which serves as an alternative to the elapse of time from the production time (L/O), an influence of change with time can be evaluated, while when a basis is placed on the area-of-sale information, an influence of environment such as in a cold region, a temperate region, and a tropical region can be evaluated. Such an evaluation is carried out with respect to the monitoring frequency on a failure diagnosis target basis.

The monitoring frequency collecting device 3 further includes a maintenance notifying portion 35 for judging, on the basis of time-sequence data of monitoring frequency concentrated from an arbitrary vehicle and controlled by the vehicle database 31, an operation state of the self-diagnosing portion 21 of the vehicle, and for, when judging that the operation state is 25 degraded, sending maintenance information to the vehicle.

For example, when the concentrated monitoring frequency is below a predetermined threshold value because of change with time and the like, the maintenance notifying portion 35 is configured to transmit maintenance information to the vehicle, and the on-board machine 22 of the vehicle to which the maintenance information was transmitted is configured to display, on a display device of a navigation system of the vehicle, the maintenance information, e.g., a guidance screen of maintenance items, information about necessary members, and a closest retailer or a repair shop. The guidance may be auditory notification by providing an audio outputting device.

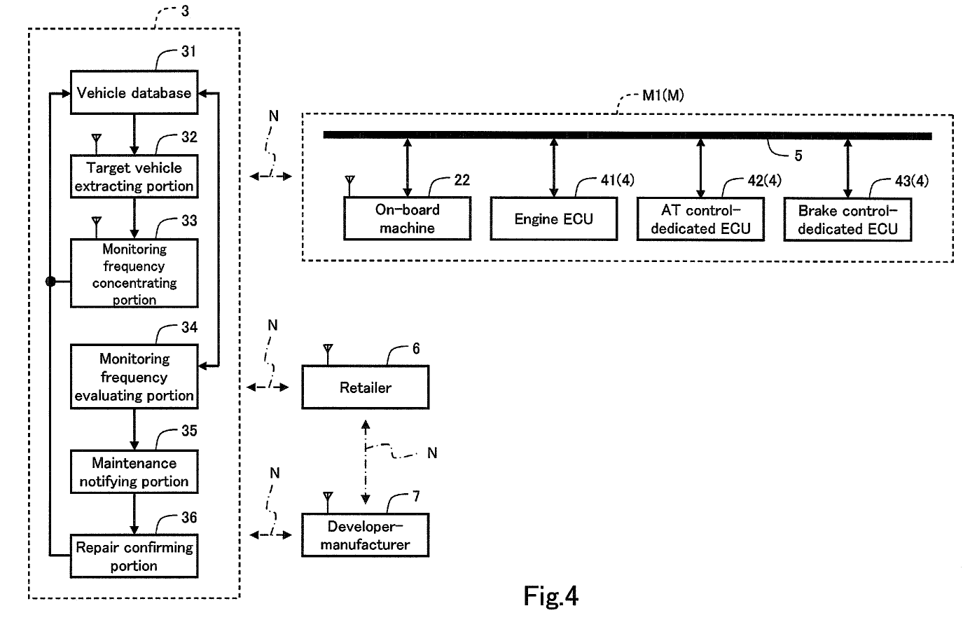

Referring to FIG. 4, the monitoring frequency collecting device 3 is configured to transmit the maintenance information of the vehicle also to a closest retailer 6 or a repair shop in order to carry out preparations such as securing necessary members and arrangement of a repair schedule.

It should be noted that in FIG. 4, communication and contact for the monitoring frequency collecting device 3, the retailer 6, and a manufacturer 7 is not limited to a mobile communication network N as shown; it is possible to use, for example, communication infrastructure such as a WAN and a telephone line.

The monitoring frequency collecting device 3 is further configured to include a repair confirming portion 36 for, when a vehicle judged as abnormal is repaired at the retailer 6 or the like in accordance with transmission of the maintenance information, confirming whether an appropriate repair is carried out on the basis of receipt of repair completion information from the retailer 6 or the like.

Specifically, such a configuration is employed that travel pattern information for normal operation confirmation is transmitted from the monitoring frequency collecting device 3 to the vehicle that has completed repairing, and a result of a diagnosis by the self-diagnosing portion 21 activated during travel in the travel pattern that the vehicle received is transmitted to the monitoring frequency collecting device 3 so that the repair confirming portion 36 confirms that an appropriate repair was carried out on the basis of the transmitted diagnosis result. Such information is stored in the vehicle database 31 as a failure history.

An example of the travel pattern information, in the case of being related to the monitoring frequency of the discharge gas sensor, may be configured as a self-diagnosis program that checks an output value of the discharge gas sensor when, for example, the amount of fuel injection is controlled at a predetermined level while the engine is in an idling state.

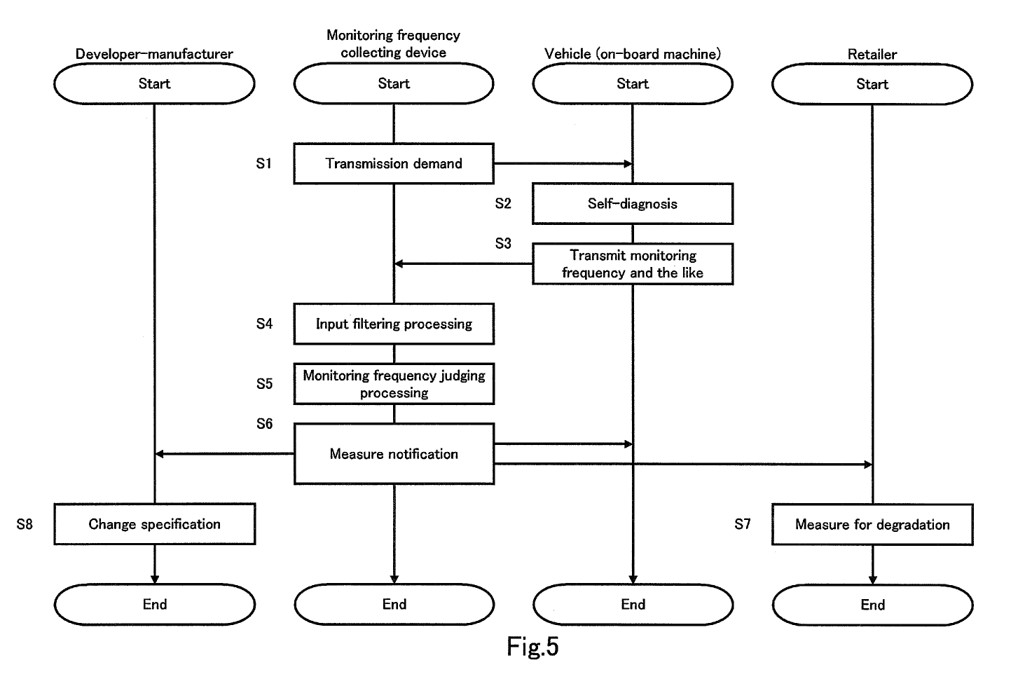

A vehicle diagnosis operation carried out by the on-board machine 22 and the monitoring frequency collecting device 3 will be described below on the basis of a flowchart shown in FIG. 5.

The target vehicle extracting portion 32 of the monitoring frequency collecting device 3 extracts a concentration target vehicle from control information registered in the vehicle database 31 on the basis of production control information, and the monitoring frequency concentrating portion 33 makes a transmission demand to the extracted vehicle (S1).

The on-board machine 22 of the vehicle that has received the transmission demand reads from the EEPROM 221 vehicle side control information that results from a diagnosis carried out by the self-diagnosing portion 21 up to this time and is accumulated and recorded, such as the monitoring frequency, the number of times of monitoring, the number of times of travel, and further an accumulated travel distance and failure history of the vehicle, and area-of-sale information of the vehicle (S2). The on-board machine 22 transmits the vehicle side control information to the monitoring frequency collecting device 3 (S3).

The monitoring frequency evaluating portion 34 carries out filtering processing for extracting evaluation target data from vehicle side control information such as monitoring frequencies received from vehicles (S4), and executes an evaluation of the extracted monitoring frequencies (S5). In the filtering processing, filtering conditions are set appropriately in accordance with the purpose of the evaluation, examples including whether the accumulated travel distance from the previous evaluation exceeds a predetermined distance, and whether the evaluation target data is data related to a vehicle of a particular area from retailer information.

After a general evaluation, an individual evaluation is carried out, and when the monitoring frequency of a particular vehicle is abnormal, the maintenance notifying portion 35 transmits maintenance information to the vehicle (S6).

In accordance with the maintenance information, a retailer prepares members and workers in preparation for arrival of the vehicle in which an abnormality has occurred (S7), and a manufacturer-seller analyzes a repair result and a failed member from the retailer and takes precautions measures including specification changes in vehicles that are the same type as the abnormal vehicle or vehicles that were manufactured in the same month and year as the abnormal vehicle (S8).

Another embodiment will be described below.

While in the above embodiment description is made of the configuration where the on-board machine 22 transmits the monitoring frequency and necessary information in response to a transmission demand from the monitoring frequency collecting device 3, it is also possible to employ such a configuration that the on-board machine 22 transmits the monitoring frequency alone.

While in the above embodiment description is made of the configuration where the monitoring frequency is transmitted only when the counted number of times of travel is equal to or more than a predetermined counted value in order to avoid increased communication traffic, it is also possible to employ such a configuration that a threshold value for the number of times of monitoring or the monitoring frequency is set in advance so that at less than the threshold value, the monitoring frequency is not transmitted. It is also possible to employ such a configuration that threshold values are set for all the number of times of travel, the number of times of monitoring, and the monitoring frequency so that the monitoring frequency is transmitted only when the values of the foregoing are all equal to or more than respective threshold values.

When transmission of the monitoring frequency is avoided, such a configuration may be employed that vehicle side control information including the accumulated travel distance and failure history of the vehicle, and area-of-sale information of the vehicle is transmitted. In this case, the monitoring frequency evaluating portion 34 can assume a cause that makes the monitoring frequency equal to or less than the threshold value.

Further, when the monitoring frequency stored in the EEPROM 221 sticks to zero or a maximum value, such a configuration may be employed that the monitoring frequency is not transmitted as being a case of an abnormality in the EEPROM 221 or a circuit on a periphery thereof.

From the viewpoint of avoiding increased communication traffic, such a configuration may be employed that an automatic transmission condition setting signal is transmitted in advance to vehicles so that a self-transmission is carried out when the vehicles satisfy an automatic transmission condition that is set. As an automatic transmission condition, the accumulated travel distance, the monitoring frequency, and the like may be set.

Such a configuration may be employed that collation data indicating whether a transmission demand is genuine is added to transmission demand data to the vehicles from the monitoring frequency collecting device 3 and transmitted, and that a collating portion is provided on the vehicle side for judging for a genuine transmission demand so that the vehicle side responds only to a genuine transmission demand. This eliminates a false transmission demand made by pretension and the like.

Also such a configuration may be employed that an encoding portion is provided for transmitting encoded collation data to the vehicle side in order to accomplish the purpose of maintaining security such as prevention of tampering of transmitted data, and an encoding portion is provided for encoding return data from the vehicle side and transmitting the return data.

When, for example, such a contract is made that a vehicle introduces a system enabling an Internet connection from the vehicle, the collation data may be a personal identification number and the like that a user of the system determines at the time of the contract.

During a high speed travel or a travel with frequent acceleration and deceleration, the processing load on each of the ECUs is large and the capacity of data coming and going through the CAN bus is large, which might cause, for example, task missing to occur such that the self-diagnosing portion 21, which is low in priority in engine control-dedicated ECUs compared with important control such as injection control, is not executed in accordance with its execution period and delayed. In this case, the monitoring frequency might not be updated appropriately. It is also necessary to avoid in advance situations that might undermine control of vehicles of low priority caused by excessive processing load on the ECUs.

In view of this, it is preferable that the on-board machine 22 include a transmission judging portion for judging whether to transmit the monitoring frequency and the like on the basis of the travel condition of the vehicle at the time of a transmission demand from the monitoring frequency collecting device 3.

When the control load on the ECUs is judged to be low for a predetermined period of time such as in a vehicle stop state, an idling state, and a constant travel state in which axel openness is constant and there is no drastic acceleration and deceleration, then the transmission judging portion judges this case as returnable, while when the control load on the ECUs is judged to be high such as when the transmission is frequently operated so that the axel and the brake are operated frequently or for a long period of time, then the transmission judging portion judges this case as non-returnable. When the transmission judging portion judges for returnability, the control portion transmits the monitoring frequency and the like to the monitoring frequency collecting device 3, while when the transmission judging portion judges for non-returnability, the control portion suspends transmission of the monitoring frequency and the like.

The information suspended in transmission such as the monitoring frequency may be configured to be transmitted at the time of the next transmission demand from the monitoring frequency collecting device 3 or when the transmission judging portion judges for returnability.

While in the above embodiment description is made of the case where the target vehicle extracting portion 32 extracts a concentration target vehicle from which a monitoring frequency is concentrated on the basis of production control information every time a predetermined concentration period of time elapses, it is also possible to predict a concentration time at which the next accumulated travel distance will become a predetermined travel distance from accumulated travel distances concentrated from vehicles and past concentration times in order to extract a vehicle that satisfies the time as a concentration target vehicle.

While in the above embodiment description is made of the case where the monitoring frequency collecting device includes a monitoring frequency evaluating portion, the provision of the monitoring frequency evaluating portion is not limited to the monitoring frequency collecting device; the monitoring frequency collecting device may be provided in an information processing device on the manufacturer side connected through a communication line.

The on-board machine transmitting the monitoring frequency may be configured to be incorporated in an electronic control device that carries out failure diagnosis so that the functions are integrated.

The above embodiments are provided by way of example only, and it will be appreciated that the specific configurations and the like of the blocks may be modified appropriately within a range where the advantageous effects of the present invention are exhibited.

The above plurality of embodiments may be realized individually or combined within a range where the advantageous effects of the present invention are exhibited.

1. A failure-diagnosing on-board machine provided in a vehicle, the on-board machine comprising:
a storing portion for storing information related to a failure diagnosis; and
a control portion for, upon receiving a transmission demand from an external frequency collecting device, transmitting an executing frequency of the failure diagnosis on the basis of the information related to the failure diagnosis stored in the storing portion, the failure diagnosis being executed when a predetermined travel condition is satisfied.

2. The on-board machine according to claim 1, wherein: the executing frequency of the failure diagnosis is a ratio between a counted value indicating the number of times of travel counted when the travel condition is satisfied and a counted value indicating the number of times of monitoring counted when a judgment as to normality or abnormality is made by a failure diagnosis carried out during the travel; and the control portion transmits the executing frequency of the failure diagnosis when the counted value indicating the number of times of travel is equal to or more than a predetermined counted value or when the executing frequency of the failure diagnosis is within a predetermined frequency range.

3. The on-board machine according to claim 1, wherein at the time of the transmission demand for the executing frequency of the failure diagnosis from the frequency collecting device, the control portion transmits at least information including area-of-sale information or travel distance information of the vehicle together with the executing frequency of the failure diagnosis or in place of the executing frequency of the failure diagnosis.

4. A frequency collecting device comprising:
a vehicle database for storing vehicle information including a failure diagnosis executing frequency calculated from a failure diagnosis of a vehicle;
a target vehicle extracting portion for extracting a concentration target vehicle from the vehicle database; and
a frequency concentrating portion for concentrating through a communication line the failure diagnosis executing frequency from the concentration target vehicle extracted by the target vehicle extracting portion and for registering the failure diagnosis executing frequency to the vehicle database,
wherein the target vehicle extracting portion extracts the concentration target vehicle on the basis of production control information including at least a type and a production time of the vehicle.

5. A frequency collecting method comprising:
connecting a vehicle and an external frequency collecting device with one another through a communication line, the vehicle having an accumulated record of an executing frequency of a failure diagnosis carried out under a predetermined travel condition; and
concentrating to the frequency collecting device an executing frequency of a failure diagnosis of a vehicle satisfying at least a predetermined concentration condition.

6. The on-board machine according to claim 2, wherein at the time of the transmission demand for the executing frequency of the failure diagnosis from the frequency collecting device, the control portion transmits at least information including area-of-sale information or travel distance information of the vehicle together with the executing frequency of the failure diagnosis or in place of the executing frequency of the failure diagnosis.
